(19) United States
(12) Patent Application Publication
(10) Pub. No.: US 2006/0279726 A1
(43) Pub. Date: Dec. 14, 2006

(54) Facial liveness assessment system

(76) Inventor: Charles Galambos, Guilford (GB)

Correspondence Address: STITES & HARBISON PLLC, 1199 NORTH FAIRFAX STREET, SUITE 900, ALEXANDRIA, VA, 22314, US

(21) Appl. No.: 10/564,362

(22) PCT Filed: Jul. 15, 2004
(86) PCT No.: PCT/GB04/03072

§ 371 Date: Jun. 12, 2006

(30) Foreign Application Priority Data
Jul. 16, 2003 (GB) 0316631.1

(51) Int. Cl. G06K 9/74

(52) U.S. Cl. 356/71; 356/6

(57) ABSTRACT

A system for assessing whether or not a subject's face is a real face is described. The face of the subject is illuminated under different illumination conditions, and images of the subject are obtained for each different illumination condition. The difference between the images obtained at different illumination conditions can be used to determine if the subject's face is the face of a real person.

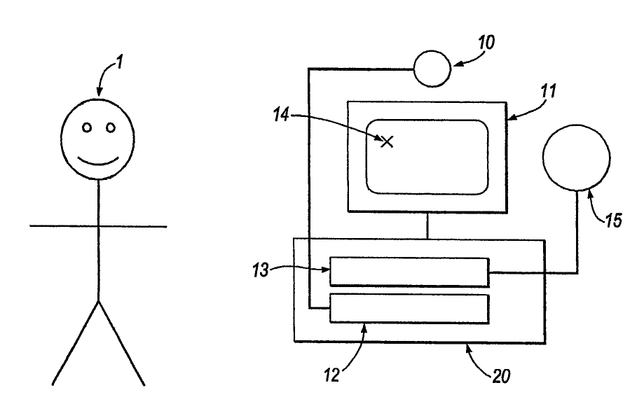

This invention relates to a system and method for assessing whether or not a subject's face is the face of a real (live) person.

Prior art systems for use in facial identification systems, may sometimes be prone to fraudulent misuse by impostors. This can occur when an impostor attempts to trick the system by presenting a photograph or a video recording of the true client to the system. In some prior art systems the impostor's attempt to gain access to the system in this way may be successful, and the impostor will have gained access to the true client's system. Obviously, it is desirable to improve the security of the system to avoid this type of impostor attack.

According to the invention there is provided a system for assessing whether or not a subject's face is the face of a real person, the system comprising; control means for controlling optical radiation incident on the subject's face, detecting means for detecting the optical radiation reflected at the subject's face, and processing means responsive to the control means for analysing the reflected optical radiation detected by the detecting means to assess whether or not the subject's face is that of a real person.

In a preferred embodiment the control means includes a controllable optical radiation source (operating in the visible or infra-red region of the electromagnetic spectrum) arranged to direct optical radiation sequentially under different illumination conditions onto the subject's face.

In this arrangement the detecting means will detect the optical radiation reflected by the subject's face each time the illumination conditions of the subject's face changes.

The illumination conditions may be changed by altering the position of the controllable optical radiation source; using the controllable optical radiation source to illuminate different regions of the subject's face; changing the intensity or the wavelength of the radiation emitted by the optical radiation source.

In a preferred embodiment, the processing means determines whether the subject's face is real by looking at the difference between the optical radiation detected by the detecting means under the different illumination conditions.

In an alternative embodiment the control means comprises an optical radiation source for illuminating the subject's face and means to direct the subject's gaze in different directions whilst the subject's face is illuminated. Preferably the means to direct comprises means to move a shape on a display screen placed in the subject's line of sight, and the detection means detects the optical radiation reflected by the subject's face each time the position of the subject's face changes, as the subject's gazes follows the means to direct.

In this embodiment the processing means determines whether the subject's face is real by looking at differences between the reflected radiation detected by the detecting means for each different position of the subject's face, as the gaze of the subject follows the means to direct.

According to the invention there is also provided a method for assessing whether or not a subject's face is the face of a real person, the method comprising; providing optical radiation to be incident on the subject's face, detecting the optical radiation reflected at the subject's face, and analysing the detected optical radiation to assess whether or not the subject's face is that of a real person.

Embodiments of the invention are now described, by way of example only, with reference to the sole FIGURE of the drawings.

As can be seen from the FIGURE, the system typically comprises a monitor (11), a camera (10), a source of optical radiation (15) and a computer (20). The computer (20) includes processing means (12) and control means (13). The subject's face (1) whose genuineness is to be tested is positioned in front of the camera (10).

The subject (1) undergoes the process of ‘active illumination’ whereby two images of the subject's face are captured sequentially by the camera (10) under different illumination conditions.

In one embodiment of the invention, a first illumination condition is set up. In the first illumination condition the source of optical radiation (15) of the system is configured to provide a controlled illumination condition. In this case, the source (15) is a light source and the face of the subject (1) is illuminated by the light source (15) and also by the ambient illumination conditions already existing. The particular illumination condition of the light source (15) (e.g. its intensity) can be controlled by the control means (13). An image of the subject's face as illuminated under this first illumination condition is captured by the camera (10), to be subsequently analysed by the processing means (12). A second illumination condition is then set up. In this embodiment, this second illumination condition is obtained by removing the illumination provided by the light source (15) and capturing an image of the subject's face as illuminated solely by the ambient illumination. The camera (10) captures an image of the subject's face under the ambient illumination, for subsequent analysis by the processing means (12).

The processing means (12) calculates a difference between the images obtained by the camera (10) under the two different illumination conditions. Generally, the illumination conditions are controlled such that objects in the background are not illuminated, leaving only the face in the foreground illuminated. Correction for slight movements of the head between image captures is done using standard motion estimation techniques.

If the subject's face is that of a real person, the ‘difference image’ obtained in this way will exhibit certain characteristic features which demonstrate that the face is that of a real person. Conversely, if the subject's face is not that of a real person, but is provided by a photograph or video recording, say, the ‘difference image’ would not exhibit the characteristic features signifying the face of a real person, allowing imposter attacks and other non-faces to be detected.

In the embodiment described above, the controlled illumination is provided by light source (15) such as a dedicated lamp. The illumination could alternatively be provided by any other light-emitting device, such as a computer display screen, such as monitor (11). The optical radiation provided by source (15) or other means may be in the visible region, or in the infra-red region.

As described above, in the first embodiment the illumination conditions are changed by simply turning off the light source (15) used in the first illumination condition. Alternatively, the illumination conditions could be changed by changing the intensity of the optical radiation emitted by the source (15), or by changing the position of the optical radiation source (15) with respect to the subject's face, or by changing the wavelength of the optical radiation emitted by the optical radiation source (15).

Also, if the optical radiation is being provided by a light-emitting device such as a computer screen (11), it may be provided in a particular pattern which illuminates different regions of the subject's face in different ways. It is possible to use the control means (13) to change this pattern, so that under the first illumination condition the subject's face is illuminated with a first pattern, and under the second illumination condition the subject's face is illuminated with a second, different pattern.

It is also possible that the pattern provided to illuminate the subject's face is a moving pattern. Each time the pattern moves the illumination condition of the subject's face is changed, so different regions of the subject's face will be illuminated. The camera (10) takes an image of the subject's face each time the pattern moves and changes the illumination condition.

In the embodiments previously described the subject's face is illuminated sequentially under first and second different illumination conditions. It is entirely possible to illuminate the face under a series of different illumination conditions and obtain several ‘difference images’ which can be used to determine if the subject's face is a real face.

In an alternative embodiment of the invention, a guide icon (14) is provided on the screen of monitor (11). The illumination conditions provided by the optical radiation source (15) (or monitor (11)) are maintained at constant level as the position of the guide icon (14) on the screen changes. The subject (1) is instructed to move their gaze so that they follow the movement of the guide icon (14) around the monitor (11). The camera (10) takes an image of the subject's face each time the position of the guide icon (14), and therefore the position of the subject's face, changes. The processing means (12) receives each image and analyses the differences between the images. The differences between the images can be used to determine whether the subject's face is that of a real person, as described earlier.

In all of the embodiments herein described the processing means analyses the radiation reflected at the subject's face under the different illumination conditions to produce a ‘difference image’. The ‘difference image’ is analysed to determine if the subject's face is the face of a real person. It is possible that the optical radiation is reflected at the subject's face, and then detected, but that a ‘difference image’ is not produced. Instead the processing means analyses the reflected optical radiation in another way, numerically, for example, to determine if the subject's face is that of a real person.

Once the system has determined whether the subject's face is that of a real person, the subject can then have their identity verified by a face verification system such as that described in PCT publication WO 01/91041.

In a face verification system there are generally several processing stages. Firstly, the image of the client is ‘grabbed’ by a camera, for example. Then the position of the face within the image has to be identified and localised. Once the face has been localised the image has to be normalised for illumination and geometric transformations. This enables a suitable representation of the face to be computed before the identity of the face is finally verified.

All of these different stages are very sensitive to the illumination conditions at the time the particular image of the subject's face is obtained. In some cases, it is not uncommon for the subject to be falsely rejected, or for an impostor to be incorrectly accepted due to small uncontrolled variations in the illumination conditions.

If the illumination conditions are known at all times then the overall performance of the system will improve, and the illumination of the face can be carefully controlled during the acquisition of images. The system described with reference to the FIGURE could be used to provide such controlled illumination conditions for use in facial verification system.

1. A system for assessing whether or not a subject's face is the face of a real person, the system comprising; control means for controlling optical radiation incident on the subjects face, detecting means for detecting optical radiation reflected at the subject's face, and processing means responsive to the control means for analysing the reflected optical radiation detected by the detecting means to assess whether or not the subject's face is that of a real person.

2. A system as claimed in claim 1 wherein said control means includes a controllable optical radiation source.

3. A system as claimed in claim 2 wherein said controllable optical radiation source is arranged to direct optical radiation sequentially under different illumination conditions onto the subject's face.

4. A system according to claim 3 wherein the controllable optical radiation source directs optical radiation onto the subject's face under a particular illumination condition, the detecting means detects the optical radiation reflected at the subject's face under the particular illumination condition, the controllable optical radiation source then directs optical radiation onto the subject's face under a different illumination condition and the detecting means detects the optical radiation reflected at the subject's face under said different illumination condition.

5. A system according to claim 3 or claim 4 wherein the position of said controllable optical radiation source with respect to the subject's face is changed to provide the different illumination conditions.

6. A system accordingly to claim 3 or claim 4 wherein said controllable optical radiation source is arranged to direct light onto different regions of the subject's face to provide different illumination conditions.

7. A system according to claim 3 or claim 4 wherein the intensity of the optical radiation emitted by said controllable optical radiation source is changed to provide the different illumination conditions.

8. A system according to claim 3 or 4 wherein the wavelength of the optical radiation emitted by said controllable optical radiation source is changed to provide the different illumination conditions.

9. A system according to any of claims 3 to 8 wherein the processing means determines whether the subject's face is real by analysing a difference between the reflected optical radiation detected by the detecting means under the different illumination conditions.

10. A system as claimed in claim 1 wherein said control means comprises a controllable optical radiation source for illuminating the subject's face and means to direct the subject's gaze in different directions whilst the subject's face is illuminated.

11. A system as claimed in claim 10 wherein said means to direct comprises means to move a shape on a display screen placed in the subject's line of sight.

12. A system according to claim 10 or claim 11 wherein the detecting means detects optical radiation reflected at the subject's face each time the position of the subject's face changes, as the subject's gaze follows the means to direct.

13. A system according to claim 12 wherein the processing means determines whether the subject's face is real by analysing differences between the reflected radiation detected by the detecting means for each different position of the subject's face, as the gaze of the subject changes to follow the means to direct.

14. A system according to any preceding claim wherein the controllable optical radiation source operates in the visible region.

15. A system according to any of claims 1 to 13 wherein the controllable optical radiation source operates in the infra-red region.

16. A system according to any preceding claim wherein the controllable optical radiation source is a dedicated light source.

17. A system according to any of claims 1 to 15 wherein the controllable optical radiation source is a light emitting display device.

18. A system according to claim 17 wherein the light emitting display device is a computer monitor.

19. A system according to any preceding claim wherein the detection means is a camera.

20. A facial verification system including a system for assessing whether or not a subject's face is the face of a real person according to any preceding claim.

21. A method for assessing whether or not a subject's face is the face of a real person, the method comprising; causing optical radiation to be incident on the subject's face, detecting the optical radiation reflected at the subject's face, and analysing the detected optical radiation to assess whether or not the subject's face is that of a real person.

22. A method as claimed in claim 21 wherein said optical radiation is provided by a control means, including a controllable optical radiation source.

23. A method as claimed in claim 22 wherein said controllable optical radiation source is arranged to direct said optical radiation sequentially under different illumination conditions onto the subject's face.

24. A method according to claim 23 including the steps of directing said optical radiation from the controllable optical radiation source onto the subject's face under a particular illumination condition, detecting the optical radiation reflected at the subject's face under the particular illumination condition, directing said optical radiation from the controllable optical radiation source onto the subject's face under different illumination conditions and detecting said optical radiation reflected at the subject's face under the different illumination conditions.

25. A method according to claim 23 or claim 24 wherein the position of the controllable optical radiation source with respect to the subject's face is changed to provide the different illumination conditions.

26. A method according to claim 23 or claim 24 wherein the controllable optical radiation source is arranged to direct optical radiation onto different regions of the subject's face to provide different illumination conditions.

27. A method according to claim 23 or claim 24 wherein the intensity of the optical radiation emitted by the controllable optical radiation source is changed to provide the different illumination conditions.

28. A method according to claim 23 or claim 24 wherein the wavelength of the optical radiation emitted by the controllable optical radiation source is changed to provide the different illumination conditions.

29. A method according to any of claims 23 to 28 including the step of determining whether the subject's face is real by analysing the difference between the reflected optical radiation detected under the different illumination conditions.

30. A method as claimed in claim 21 including the step of directing the subject's gaze in different directions whilst the subjects face is illuminated by said optical radiation.

31. A method as claimed in claim 30 wherein the step of directing the subject's gaze is performed by moving a shape on a display screen placed in the subject's line of sight.

32. A method according to claim 30 or claim 31 wherein said optical radiation reflected by the subject's face is detected each time the position of the subject's face changes, as the subject's gaze is directed in different directions.

33. A method according to claim 32 including the step of determining whether the subject's face is real by analysing the differences between the reflected radiation detected for each different position of the subject's face, as the gaze of the subject is directed in different directions.

34. A method according to any of claims 21 to 33 wherein the optical radiation provided on the subject's face is in the visible region.

35. A method according to any of claims 21 to 33 wherein the optical radiation provided on the subject's face is in the infra-red region.

36. (canceled)

37. (canceled)
